(19) United States
(12) Patent Application Publication
(10) Pub. No.: US 2013/0306209 A1
(43) Pub. Date: Nov. 21, 2013

(54) Tire Tread

(71) Applicant: Matthieu Bonnamour, Clermont-Ferrand Cedex 9 (FR)

(72) Inventor: Matthieu Bonnamour, Clermont-Ferrand Cedex 9 (FR)

(21) Appl. No.: 13/877,088

(22) PCT Filed: Sep. 28, 2011
(86) PCT No.: PCT/EP2011/066813

§ 371 Date: Jun. 19, 2013

Related U.S. Application Data
(60) Provisional application No. 61/439,631, filed on Feb. 4, 2011.

(30) Foreign Application Priority Data
Sep. 30, 2010 (FR) 1057909

(51) Int. Cl. B60C 11/13

(52) U.S. Cl. CPC B60C 11/1307
USPC 152/209.21

(57) ABSTRACT

A tire tread produced from a rubber composition having a shore A hardness between 58 and 65, inclusive, and provided with a rolling surface, configured to be in contact with the ground, and with a tread pattern formed from motifs in relief, the tread having a plurality of incisions of width WI between 0.3 mm and 2 mm, inclusive, and a depth DI, each incision being delimited by at least two separate rubber walls, at least one of said incisions being delimited by at least one wall provided with at least one protuberance with a maximum thickness TMAX projecting from said wall in order to reduce the width of the incision, the protuberance extending, in the direction of the depth DI of the incision, between an internal depth DPI and an external depth DPE, the internal depth DPI and the external depth DPE being non-zero and the maximum thickness TMAX being greater than or equal to 40% of the width WI of the incision.

### RELATED APPLICATIONS

This is a U.S. National Phase Application under 35 USC 371 of International Application PCT/EP2011/066813 filed Sep. 28, 2011.

This application claims the priority of French application no. 10/57909 filed Sep. 30, 2010 and U.S. Provisional application No. 61/439,631 filed Feb. 4, 2011, the content of both of which are hereby incorporated by reference.

### FIELD OF THE INVENTION

The present invention relates to passenger vehicle tires and in particular to the treads of such tires.

### BACKGROUND OF THE INVENTION

All vehicle manufacturers today are faced with having to reduce fuel consumption as an environmental and economic necessity. The tires with which vehicles are equipped may make a not insignificant contribution to lowering consumption. It is therefore becoming increasingly important to reduce the rolling resistance of tires.

Rolling resistance is mainly due to the fact that the rubber compounds from which tires are made are viscoelastic materials. This type of material dissipates energy in the form of heat when it undergoes deformation. As the tire rolls, it deforms under the effect of the load, becoming flattened in the contact area. This deformation leads to energy losses; hence the rolling resistance.

Among the factors that have an influence on energy dissipation, the following may be mentioned: the stiffness of the material of the tire tread; the stressing frequency; the operating temperature; and the degree of deformation. The capability of materials to dissipate energy is associated with the drop in stiffness that the deformation causes (“non-linearity”).

To lower the rolling resistance of tires, it is therefore advantageous to use low-dissipation materials. However, using such materials leads to a number of drawbacks, such as for example lower wear resistance of the treads and less grip.

Addressing these drawbacks leads to the use of treads made from materials having a relatively low stiffness. Thus, it has been found that rubber compositions having a Shore A hardness that is greater than or equal to 55 but less than or equal to 70 enable a highly advantageous compromise between grip, wear and rolling resistance to be achieved.

The low stiffness of these rubber compositions used in the tread does however have drawbacks. In particular, it results in a lower cornering stiffness, that is to say the tire responds less well to a movement of the steering wheel, this having a negative effect on the behaviour of the vehicle. It is possible to re-establish cornering stiffness by reducing the radial height of the tread pattern, but this reduction leads to impaired wear resistance of the tread.

### SUMMARY OF THE INVENTION

One of the objectives of the present invention is to provide a tread having a very low rolling resistance combined with a satisfactory cornering stiffness and good wear resistance.

This objective is achieved by producing the tread from materials having a relatively low stiffness and by making incisions that are delimited by at least two rubber walls and at least one of the rubber walls being provided with protuberances that come into contact with the opposite wall when that portion of the tread having the incision comes into contact with the ground on which the tire fitted with the tread rolls.

More precisely, this objective is achieved by a tire tread produced from a rubber composition having a Shore A hardness that is greater than or equal to 58 and less than or equal to 65 and provided with a rolling surface, configured to be in contact with the ground, and with a tread pattern formed from motifs in relief, the tread having a plurality of incisions of width WI that is greater than or equal to 0.3 mm and less than or equal to 2 mm and a depth DI, each incision being delimited by at least two separate rubber walls, at least one of said incisions being delimited by at least one wall provided with at least one protuberance with a maximum thickness TMAX projecting from said wall in order to reduce the width of the incision, the protuberance extending, in the direction of the depth DI of the incision, between an internal depth DPI and an external depth DPE, the internal depth DPI and the external depth DPE being non-zero and the maximum thickness TMAX being greater than or equal to 40% of the width WI of the incision.

The viscoelastic property of polymer is studied by dynamic mechanical analysis where a sinusoidal force (stress σ) is applied to a material and the resulting displacement (strain) is measured. For a perfectly elastic solid, the resulting strain and the stress will be perfectly in phase. For a purely viscous fluid, there will be a 90 degree phase lay of strain with respect to stress. Viscoelastic polymers have characteristics in between, i.e. some phase lag will occur during DMA (dynamic mechanical analysis) tests.

σ=σ₀ sin(tω+δ)

ε=ε₀ sin(tω)

where
ω is frequency of strain oscillation,
t is time,
δ is phase lag between stress and strain.

The storage modulus E″ measures the stored energy, representing the elastic portion, and the loss modulus E′ measures the energy dissipated as heat, representing the viscous portion. The tensile storage and loss moduli are defined as follows:

$${E}^{″} = \frac{{σ}_{0}}{{ɛ}_{0}} sin δ$$

$${E}^{′} = \frac{{σ}_{0}}{{ɛ}_{0}} cos δ$$

$$tan δ = \frac{{E}^{″}}{{E}^{′}}$$

Preferably, according to an embodiment of the invention, the rubber composition has a tan δ at 40° C. and 10 Hz that is greater than or equal to 0.19 and less than or equal to 0.25. The tan δ at 40° C. is a good measure of the rolling resistance of the rubber composition.

According to one advantageous embodiment, the radial height HTP of the tread pattern is greater than or equal to 5 mm and less than or equal to 8 mm (and preferably greater than or equal to 6 mm and less than or equal to 7 mm) when the tire is new. Such a very unusual radial height HTP makes it possible for the cornering stiffness obtained with the tread to be further increased.

According to another advantageous embodiment, the maximum thickness TMAX of each protuberance is greater than or equal to 60% of the width WI of the incision.

According to a third advantageous embodiment, the difference between said maximum thickness TMAX of the protuberance and the width WI of the incision is greater than or equal to 0.15 mm and less than or equal to 0.3 mm.

According to a fourth advantageous embodiment, for each protuberance, the depth DPI is greater than or equal to 20% and less than or equal to 80% of the depth DI of the incision in which the protuberance is situated.

According to a fifth advantageous embodiment, the tread comprises a plurality of tread blocks having an intersection with the rolling surface, wherein the intersection of each tread block with the rolling surface has a circumferential length that is greater than or equal to 10 mm, and said plurality of incisions is provided in said plurality of tread blocks, such that the circumferential distance between two adjacent incisions is greater than or equal to 10 mm.

Of course, it is possible and even advantageous to combine these various embodiments.

The invention also relates to a tire comprising a tread according to an embodiment of the invention.

### BRIEF DESCRIPTION OF THE DRAWINGS

FIG. 1 shows a tire according to the prior art.

FIG. 2 shows a partial perspective view of a tire according to the prior art.

FIG. 3 shows, in radial cross section, a portion of a tire provided with a tread according to an embodiment of the invention.

FIGS. 4 to 7 show schematically a portion of a tread 30 according to an embodiment of the invention, having two circumferential slots 121 and 122 and a tread block 130 provided with an incision 140. FIG. 4 shows this portion in perspective while FIG. 5 shows it seen from above. FIG. 6 shows a radial section of the same portion, along the line I-I of FIG. 5, whereas FIG. 7 shows a section along the thickness of the tread block 130, along the line II-II of FIG. 5.

FIG. 8 shows a moulding element for moulding an incision in a tread according to an embodiment of the invention.

### DETAILED DESCRIPTION OF THE DRAWINGS

When using the term “radial” in the tire field, several different uses of the word by those skilled in the art should be distinguished. Firstly, the expression refers to a radius of the tire. Thus a point P1 is said to be “radially inside” a point P2 (or “radially to the inside” of the point P2) if it is closer to the rotation axis of the tire than the point P2. Conversely, a point P3 is said to be “radially outside” a point P4 (or “radially to the outside” of the point P4) if it is further away from the rotation axis of the tire than the point P4. Going “radially inwards” (or “radially outwards”) is understood to mean going towards smaller (or larger) radii. When referring to radial distances, this meaning of the term also applies.

In contrast, a thread or a reinforcement is said to be “radial” when the thread or reinforcing elements of the reinforcement make an angle of absolute value greater than or equal to 80° and less than or equal to 90° with the circumferential direction. It should be pointed out that, in the present document, the term “thread” should be understood in a very general sense and includes threads in the form of monofilaments, multifilaments, a cord, a yarn or an equivalent assembly, irrespective of the material constituting the thread or the surface treatment to enhance its adhesion to the rubber.

Finally, the term “radial section” or “radial cross section” is understood here to mean a section or cross section in a plane that contains the rotation axis of the tire.

An “axial” direction is a direction parallel to the rotation axis of the tire. A point P5 is said to be “axially inside” a point P6 (or “axially to the inside” of the point P6) if it is closer to the mid-plane of the tire than the point P6. Conversely, a point P7 is said to be “axially outside” a point P8 (or “axially to the outside” of the point P8) if it is further away from the mid-plane of the tire than the point P8. The “mid-plane” of the tire is the plane perpendicular to the rotation axis of the tire and lying at an equidistance from the annular reinforcing structures of each bead.

A “circumferential” direction is a direction perpendicular both to a radius of the tire and to the axial direction.

When the terms “radial”, “axial” and “circumferential” are used with regard to a tread that has not yet been fixed onto a tire (such as for example a tread for retreading a worn tire), they are used imagining the tread fixed onto the tire. To give an example, if a point P1 on the tread not yet fixed onto a tire is said to be “radially to the inside” of another point P2, this means that the point P1 will be radially to the inside of the point P2 (within the meaning of the definition given above) when the tread is fixed onto a tire.

The “rolling surface” of the tire is formed by the set of points on the tread that are liable to come into contact with a flat ground when the tire is inflated to its service pressure and is rolling on this ground.

In the context of the present document, the expression “rubber composition” denotes a rubber composition comprising at least one elastomer and at least one filler. Sometimes the synonym “rubber compound” is used for short—the expressions “rubber compound” and “rubber composition” here are interchangeable.

When referring to values of the “Shore A hardness”, it should be understood that these are hardness values measured according to the ASTM D67549T standard.

The tan δ values are measured on a viscoanalyser (Metravib VA4000), according to the ASTM D 5992-96 standard. The response of a specimen of a vulcanized composition (a cylindrical test piece 4 mm in thickness and 400 mm² in cross section), subjected to a sinusoidal stress in alternating simple shear at a frequency of 10 Hz, during a temperature scan between 0° and 100° C., under a fixed stress of 0.7 MPa, is recorded. In particular, the tan δ value observed at 40° C. is recorded.

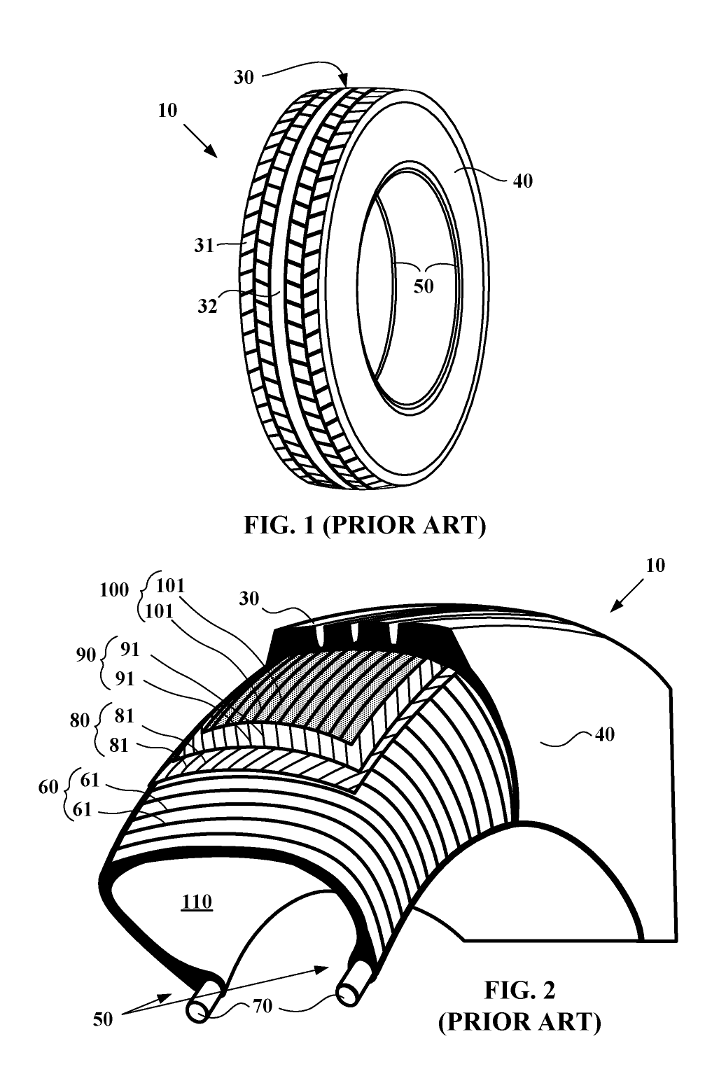

FIG. 1 shows schematically a tire 10 according to the prior art. The tire 10 comprises a crown having a crown reinforcement (not shown in FIG. 1) surmounted by a tread 30 comprising tread blocks 31 and a central rib 32. Two sidewalls 40 extending the crown radially inwards, and two beads 50 radially to the inside of the sidewalls 40.

FIG. 2 shows schematically a partial perspective view of another tire 10 according to the prior art and illustrates the various components of the tire. The tire 10 comprises a carcass reinforcement 60 consisting of threads 61 embedded in a rubber compound, and two beads 50 each having circumferential reinforcements 70 (here, bead wires) which keep the tire 10 on the rim (not shown). The carcass reinforcement 60 is anchored in each of the beads 50. The tire 10 also includes a crown reinforcement comprising two plies 80 and 90. Each of the plies 80 and 90 is reinforced by filamentary reinforcing elements 81 and 91 which are parallel in each ply and crossed from one ply to the other, making angles of between 10° and 70° to the circumferential direction. The tire further includes a hooping reinforcement 100 placed radially to the outside of the crown reinforcement, this hooping reinforcement being formed from circumferentially oriented reinforcing elements 101 wound in a spiral. A tread 30 is placed on the hooping reinforcement; it is via this tread 30 that the tire 10 comes into contact with the road. The tire 10 shown is a “tubeless” tire. It includes an “inner liner” 110 made of a rubber composition impermeable to the inflation gas and covering the internal surface of the tire.

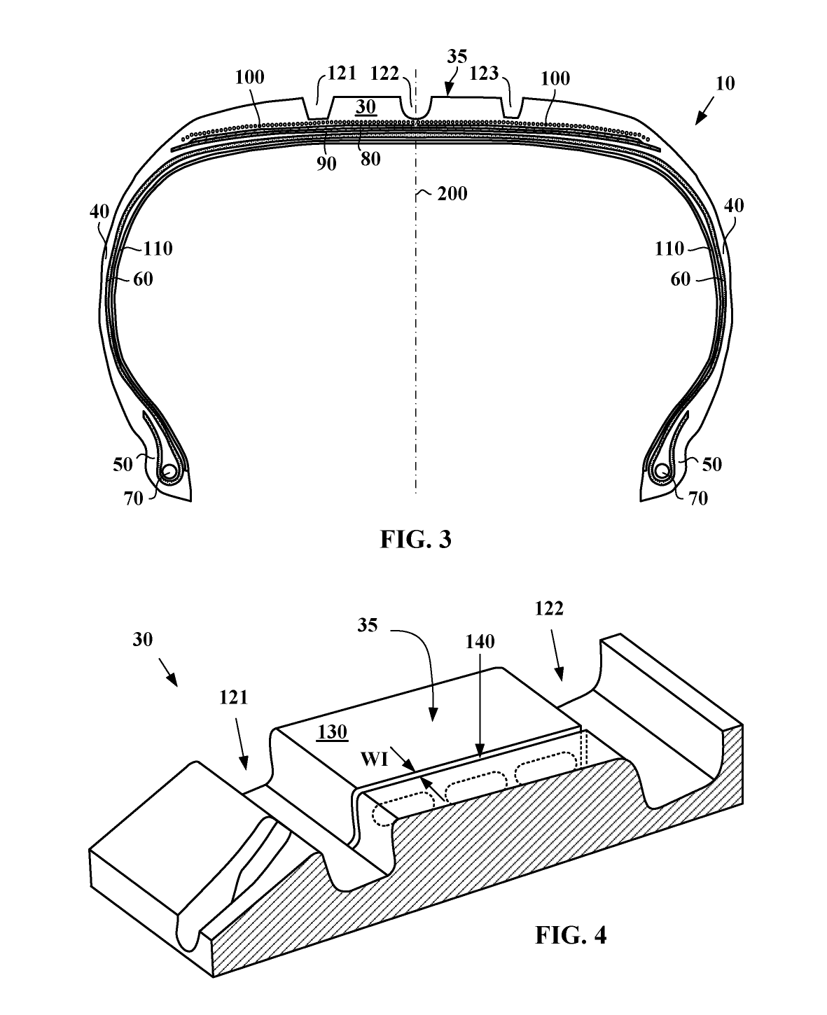

FIG. 3 shows schematically, in radial cross section, a portion of a tire 10 according to an embodiment of the invention. This tire 10 has two beads 50 designed to come into contact with a mounting rim (not shown). Each bead has an annular reinforcing structure 70 (here a bead wire), two sidewalls 40 extending the beads 50 radially outwards, the two sidewalls 40 joining in a crown comprising a crown reinforcement, formed by the plies 80 and 90, and a hooping reinforcement 100 placed radially to the outside of the crown reinforcement and surmounted by a tread 30 provided with a rolling surface 35 configured to be in contact with a ground. The crown reinforcement and the hooping reinforcement 100 extend axially on either side of the mid-plane 200 of the tire. The tire 10 also includes a carcass reinforcement 60 extending from the beads 50 through the sidewalls 40 to the crown. The carcass reinforcement comprises a plurality of carcass reinforcing elements and is anchored in the two beads to the annular reinforcing structure, in this case via an upturn around the bead wire 70.

The crown reinforcement includes a radially inner ply 80 and a radially outer ply 90, each of the plies being reinforced with filamentary reinforcing elements, the reinforcing elements of each ply being mutually parallel and the reinforcing elements of two adjacent plies being crossed from one to the other.

The hooping reinforcement 100 is formed, in a manner known to those skilled in the art, from at least one circumferentially oriented reinforcing element.

The tire 10 shown is a “tubeless” tire—it includes an “inner liner” 110 made of a rubber composition impermeable to the inflation gas, covering the internal surface of the tire.

The tread is made of a rubber composition having a Shore A hardness that is greater than or equal to 58 and less than or equal to 65, in this case equal to 62. The formulation and the compounding of rubber compositions having such a Shore A hardness is known per se and within the competence of a person skilled in the art.

As an example, Table I shows a rubber composition that can be used. The composition is given in phr (“per hundred parts of rubber or elastomer”), i.e. in parts by weight per 100 parts by weight of rubber or elastomer.

The rubber compositions are preferably based on at least one diene elastomer, a reinforcing filler and a cross linking system.

The term “diene” elastomer (or rubber) is understood, as is known, to mean an elastomer (i.e. a homopolymer or a copolymer) at least partly obtained from diene monomers, i.e. monomers carrying two carbon-carbon double bonds, whether or not conjugated. The diene elastomer used is preferably chosen from the group formed by: polybutadienes (BR); natural rubber (NR); synthetic polyisoprenes (IR); stirene-butadiene copolymers (SBR); butadiene-isoprene copolymers (BIR); stirene-isoprene copolymers (SIR); stirene-butadiene-isoprene copolymers (SBIR) and blends of these elastomers.

A preferred embodiment uses an “isoprene” elastomer, i.e. an isoprene homopolymer or copolymer, in other words a diene elastomer chosen from the group formed by natural rubber (NR), synthetic polyisoprenes (IR), the various isoprene copolymers and blends of these elastomers.

TABLE I

| | |
|---|---|
| S-SBR elastomer [1] | 80 |
| BR elastomer [2] | 20 |
| Silica [3] | 73 |
| Carbon black [4] | 3 |
| Coupling agent [5] | 5.8 |
| Plasticizing resin [6] | 20 |
| MES non-aromatic oil | 6 |
| Anti-ozone wax | 1.7 |
| Antioxidant (6PPD) [7] | 2.2 |
| DPG [8] | 1.5 |
| ZnO | 1.0 |
| Stearic acid | 2 |
| Sulphur | 1 |
| Accelerator [9] | 1.6 |
| Shore A hardness | 63 |
| tanδ at 40° C. and 10 Hz | 0.234 |

### Annotations to Table I

[1] SBR: oil-extended solution (amount expressed as dry SBR); 25% stirene, 58% 1,2-polybutadiene units and 23% trans 1,4-polybutadiene units (TG=−24° C.);
[2] BR with 4.3% 1,2-units; 2.7% trans units; and 93% cis 1,4-units (TG=−106° C.)
[3] “Zeosil 1165 MP” silica, of the “HD” type, from Rhodia;
[4] N234 series carbon black (ASTM grade)
[5] TESPT coupling agent (“Si69” from Degussa)
[6] Stirene/C₅ cut resin (“Super Nevtac 85” from Neville Chemical Company);
[7] N-1,3-dimethylbutyl-N-phenylparaphenylenediamine (“Santoflex 6-PPD” from Flexsys);
[8] diphenylguanidine (“Perkacit DPG” from Flexsys);
[9] N-cyclohexyl-2-benzothiazyl-sulphenamide (“Santocure CBS” from Flexsys)

The isoprene elastomer is preferably natural rubber or a synthetic polyisoprene of the cis-1,4 type. Among these synthetic polyisoprenes, it is preferred to use polyisoprenes having an amount (in mol %) of cis-1,4 bonds greater than 90%, more preferably still greater than 98%. According to other preferred embodiments, the diene elastomer may consist, entirely or partly, of another diene elastomer such as, for example, an SBR elastomer (E-SBR or S-SBR) possibly blended with another elastomer, for example of the BR type.

The rubber composition may also include all or some of the additives conventionally used in rubber matrices for the manufacture of tires, such as, for example, reinforcing fillers, such as carbon black or inorganic fillers such as silica, coupling agents for coupling inorganic filler, anti-aging agents, antioxidants, plasticizers or extender oils, whether the latter are of aromatic or non-aromatic nature (especially non-aromatic or very slightly aromatic oils, for example of the naphthenic or paraffinic type, having a high, or preferably a low, viscosity, MES or TDAE oils, plasticizing resins having a high TG, above 30° C.), processing aids making it easier to process the compositions in the green state, tackifying resins, a cross linking system based either on sulphur or on sulphur donors and/or a peroxide-based cross linking system, accelerators, vulcanization activators or retarders, antireversion agents, methylene acceptors and donors such as, for example, HMT (hexamethylenetetramine) or H3M (hexamethoxymethylmelamine), reinforcing resins (such as resorcinol or bismaleimide), and known adhesion promoter systems, for example of the metal salt, especially cobalt or nickel salt, type.

The compositions are manufactured in suitable mixers, using two successive preparation phases well-known to those skilled in the art, namely a first, thermomechanical working or kneading phase (called the “non-productive” phase) at high temperature, up to a maximum temperature of between 110° C. and 190° C., preferably between 130° C. and 180° C., followed by a second, mechanical working phase (called the “productive” phase) up to a lower temperature, typically below 110° C., during which finishing phase the cross linking system is incorporated.

To give an example, the non-productive phase is carried out in a single thermomechanical step lasting a few minutes (for example between 2 and 10 minutes) during which ail the necessary basic constituents and other additives, with the exception of the cross linking or vulcanization system, are introduced into a suitable mixer, such as a standard internal mixer. After the mixture thus obtained has cooled down, the vulcanization system is then incorporated in an external mixer, such as a two-roll open mill, maintained at low temperature (for example between 30° C. and 100° C.). All the ingredients are then mixed (during the productive phase) for a few minutes (for example between 5 and 15 minutes).

The vulcanization (or curing) may be carried out in a known manner, generally at a temperature between 130° C. and 200° C., preferably under pressure, for a sufficient time, which may for example vary between 5 and 90 minutes depending in particular on the curing temperature, on the vulcanization system adopted and on the rate of vulcanization of the composition in question.

Returning to the geometry of a tire according to an embodiment of the invention, the tread 30 is provided with a tread pattern formed from motifs in relief. In FIG. 3, three circumferential slots 121 to 123 are visible, but the tread also has transverse incisions (not visible in this radial cross section). The term “transverse incision” is understood here to mean incisions of which the direction of the largest dimension makes a non-zero angle with the circumferential direction.

The tread pattern has a radial height HTP as indicated in FIG. 6. This height corresponds to the maximum distance between the rolling surface and the radially innermost point of the elements forming the tread pattern (circumferential and transverse slots and incisions). When the tread is on a tire inflated to its service pressure, it is possible to determine this height by measuring the radial depth of all the slots and incisions: the radial height HTP corresponds to the maximum value of the measured depths. In a tread according to an embodiment of the invention the radial height HTP is preferably greater than or equal to 5 mm and less than or equal to 8 mm. In the present case it is 7 mm when the tire is new (i.e. unworn).

The incision 140 of depth DI (shown in FIG. 7) is delimited by at least two rubber walls 141 and 142 extending both over the entire axial width of the tread block 130 and over the entire radial height of the tread block (i.e. in a direction perpendicular to the plane of the figure). The width WI is the distance between the two rubber walls 141 and 142—here it is equal to 0.5 mm.

One of the walls defining the incision 140, namely the wall 142, is provided with three protuberances with a maximum thickness TMAX, projecting from said wall in order to reduce the width of the incision. Of course, the precise number of protuberances is not a key factor—it will be possible to provide a single wide protuberance or a larger number of smaller protuberances. The maximum thickness TMAX is measured relative to the wall 142 from which the protuberance projects. In this case, TMAX is equal to 0.3 mm. The protuberance therefore locally reduces the width of the incision to a value that corresponds to about 40% of the width WI. It is configured to rapidly establish contact with the opposite wall when this portion of the tread comes into contact with the ground on which the tire rolls. Specifically, when the tread comes into contact with the ground, the face 152 of the protuberance 150 bears on the opposite wall 141 and thus limits the deformation of the tread block 130.

During the design of the invention, the inventors understood that the use of such incisions—known per se, for example from documents JP 02/303908 and WO 01/60642—in a tread of low stiffness makes them particularly effective. They have found that the use of such incisions does not have an effect only on the shearing of the tread but also partially blocks the Poisson effect. Thus, the invention makes it possible to achieve a remarkable compromise between a low rolling resistance and excellent handling, or, in other words, between economy of wear and safety.

The protuberance extends, in the direction of the depth DI of the incision, between an internal depth DPI and an external depth DPE (shown in FIG. 7), the internal depth DPI and the external depth DPE being non-zero.

FIG. 8 shows a moulding element 250 for moulding the incision 140 with its three protuberances 150. This moulding element 250 is made in a thin metal plate with a thickness WI and a length corresponding to the desired dimensions of the incision. On one of the faces of the plate, three recesses 260 are produced by removing material using a tool of the milling cutter type.

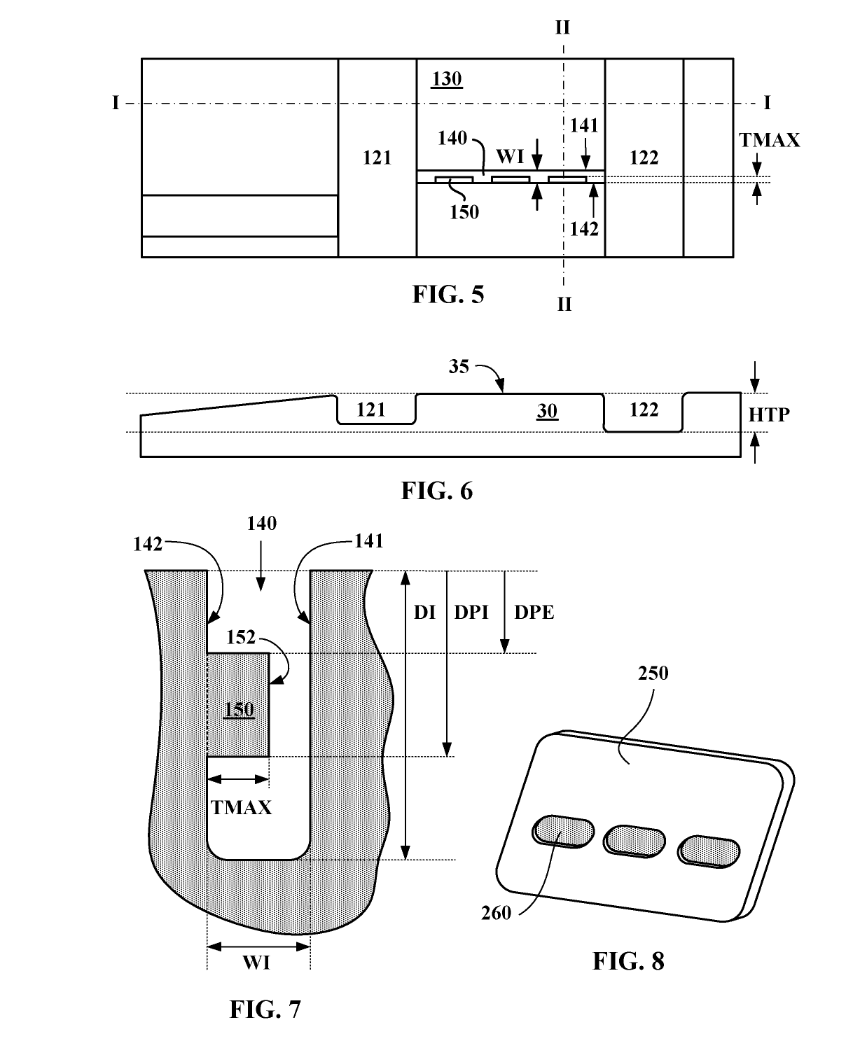

FIGS. 4 to 8 show an incision with protuberances having a very simple geometry. Of course, it is possible, and even advantageous, to provide more complex geometries, for example to make unmoulding easier, especially according to the teachings of document WO 01/60642, which is incorporated by reference.

The use of such incisions with a tread produced from a rubber composition having a low stiffness makes it possible to obtain a tread having a very low rolling resistance combined with a satisfactory cornering stiffness and good wear resistance.

Table II shows results obtained with a reference tire and with a tire according to an embodiment of the invention. The two tires, of 205/55 R 16 size, are distinguished from each other only by the stiffness of the tread and by the presence of protuberances, of the type shown in FIGS. 4 to 7, in certain transverse incisions:

TABLE II

| | Shore A | Rolling | Cornering | |
|---|---|---|---|---|
| Tire | hardness | resistance | stiffness | Wear |
| Reference | 68.5 | 100 | 100 | 100 |
| Invention | 62 | 91 | 98 | 97 |

1. A tire tread produced from a rubber composition having a Shore A hardness that is greater than or equal to 58 and less than or equal to 65 and provided with a rolling surface, configured to be in contact with the ground, and with a tread pattern formed from motifs in relief, the tread having a plurality of incisions of width WI that is greater than or equal to 0.3 mm and less than or equal to 2 mm and a depth DI, each incision being delimited by at least two separate rubber walls, at least one of said incisions being delimited by at least one wall provided with at least one protuberance with a maximum thickness TMAX projecting from said wall in order to reduce the width of the incision, the protuberance extending, in the direction of the depth DI of the incision, between an internal depth DPI and an external depth DPE, the internal depth DPI and the external depth DPE being non-zero and the maximum thickness TMAX being greater than or equal to 40% of the width WI of the incision.

2. A tread according to claim 1, wherein the radial height HTP of the tread pattern is greater than or equal to 5 mm and less than or equal to 8 mm when the tire is new.

3. A tread according to claim 2, wherein the radial height HTP of the tread pattern is greater than or equal to 6 mm and less than or equal to 7 mm when the tire is new.

4. A tread according to claim 1, wherein said maximum thickness TMAX of the protuberance is greater than or equal to 60% of the width WI of the incision.

5. A tread according to claim 1, wherein the difference between said maximum thickness TMAX of the protuberance and the width WI of the incision is greater than or equal to 0.15 mm and less than or equal to 0.3 mm.

6. A tread according to claim 1, wherein, for each protuberance, the depth DPI is greater than or equal to 20% and less than or equal to 80% of the depth DI of the incision in which the protuberance is situated.

7. A tread according to claim 1, wherein said rubber composition has a tan δ at 40° C. and 10 Hz that is greater than or equal to 0.19 and less than or equal to 0.25.

8. A tread according to claim 1, wherein the tread comprises a plurality of tread blocks having an intersection with the rolling surface, wherein the intersection of each tread block with the rolling surface has a circumferential length that is greater than or equal to 10 mm, wherein said plurality of incisions is provided in said plurality of tread blocks, and wherein the circumferential distance between two adjacent incisions is greater than or equal to 10 mm.

10. A tire comprising a tread according to claim 1.
